(19) United States
(12) Patent Application Publication
(10) Pub. No.: US 2025/0000238 A1
(43) Pub. Date: Jan. 2, 2025

(54) AUTONOMOUS MAKEUP APPLICATOR AND APPLICATION

(71) Applicant: L'Oreal, Paris (FR)

(72) Inventors: Juwan HONG, Jersey City, NJ (US); Maya KELLEY, San Francisco, CA (US); Franck GIRON, Clichy (FR); Fred ORSITA, Wayne, NJ (US)

(73) Assignee: L'Oreal, Paris (FR)

(21) Appl. No.: 18/756,104

(22) Filed: Jun. 27, 2024

Related U.S. Application Data
(60) Provisional application No. 63/511,112, filed on Jun. 29, 2023.

(30) Foreign Application Priority Data
Sep. 14, 2023 (FR) 2309672

(51) Int. Cl. A45D 44/00; A45D 40/18; B41J 3/407; B41M 5/00

(52) U.S. Cl. CPC A45D 44/005; A45D 40/18; B41J 3/4073; B41M 5/0076; A45D 2044/007

(57) ABSTRACT

A system of autonomously applying a cosmetic style including a smart device comprising an application configured to select the cosmetic style from a plurality of cosmetic styles, display the cosmetic style on an image of a body, and transmit the cosmetic style as a makeup image file, and a printer device. The printer device includes at least one position sensor, one or more reservoirs each configured to hold one or more dyes, a printer comprising a printer applicator, where the printer is configured to print the cosmetic style with the one or more dyes through the printer applicator, and a processor configured to receive the makeup image file, detect a position and a curvature of the body based on the position sensor, and direct the printer to print the cosmetic style in a specific location.

### CROSS REFERENCE TO RELATED APPLICATION

This application claims the benefit of U.S. Provisional Application No. 63/511,112 filed Jun. 29, 2023, the entire disclosure of which is hereby incorporated by reference, and French Patent Application No. 2309672 filed Sep. 14, 2023, the entire contents of which are hereby incorporated by reference.

### SUMMARY

In one aspect, disclosed herein is a system of autonomously applying a cosmetic style including a smart device comprising an application configured to select the cosmetic style from a plurality of cosmetic styles, display the cosmetic style on an image of a body, and transmit the cosmetic style as a makeup image file, and a printer device. In some embodiments, the printer device includes a sensor and one position sensor, one or more reservoirs configured to hold one or more dyes, a printer comprising a printer applicator, where the printer is configured to print the cosmetic style with the one or more dyes through the printer applicator, and a processor configured to receive the makeup image file, detect a position and a curvature of the body based on the position sensor, and direct the printer to print the cosmetic style in a specific location.

In some embodiments, the system further includes a primer configured to be applied before the cosmetic style. In some embodiments, the system further includes a topcoat configured to be applied after the cosmetic style.

In some embodiments, the printer device further includes a camera configured to take a plurality of images, wherein the specific location is further informed by the plurality of images, and a light source configured to illuminate the body. In some embodiments, the camera is a first camera, and the device further comprises a second camera, the first camera is located on a first side of the printer applicator, and the second camera is located on a second side opposite the first side of the printer applicator.

In some embodiments, the printer device further includes a user interface configured to provide a printing guide. In some embodiments, the position sensor is a rolling position sensor. In some embodiments, the rolling position sensor is configured to contact the body as the rolling position sensor rolls over the body and to measure a curvature of the body.

In some embodiments, the printer is coupled with the printer device with a flexible connector, and wherein the flexible connector is configured to articulate the printer.

In some embodiments, the image of the body is a live video feed of the smart device or the printer device.

In some embodiments, the application is further configured to recommend the cosmetic style from the plurality of cosmetic styles. In some embodiments, the recommendation is based on a trending cosmetic style, a color of a user's hair, skin, or lips, a past cosmetic style selected by the user, a shape of the user's eyes, eyebrows, nose, lips, cheeks, or forehead, a location of the user, or a color of the user's clothing.

In another aspect, disclosed herein is a method of autonomously applying a cosmetic style with the system described herein, the method including selecting the cosmetic style from a plurality of cosmetic styles, displaying the cosmetic style on an image of a body, transferring the cosmetic style as an image file to a printer device, moving the printer device over the body, and printing the cosmetic style onto the body at a specific location based on one or more position sensors on the printer device.

In some embodiments, the method further includes recommending the cosmetic style based on a trending cosmetic style, a color of a user's hair, skin, or lips, a past cosmetic style selected by the user, a shape of the user's eyes, eyebrows, nose, lips, cheeks, or forehead, a location of the user, or a color of the user's clothing.

In some embodiments, the image of the body is a live video feed from a smart device or the printer device.

In some embodiments, the method further includes recognizing a plurality of facial features in the image of the body before displaying the cosmetic style. In some embodiments, the method further includes selecting another cosmetic style in place of the cosmetic style. In some embodiments, the cosmetic style is selected from an eyebrow, an eyeshadow, a concealer, a primer, a foundation, a blush, a lipliner, a lipstick, a bronzer, an eyeliner, a freckle pattern, a facial hair, a hair design, or a highlighter.

In some embodiments, the method further includes adjusting the cosmetic style. In some embodiments, adjusting the cosmetic style includes changing a color, a size, a length, a width, a hair size, a pattern, a position, a location of the cosmetic style, or a combination thereof.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1A is an example front side of a printer device, in accordance with the present technology;

FIG. 1B is an example back side of a printer device, in accordance with the present technology;

FIG. 2A is an example exploded front side of a printer device, in accordance with the present technology;

FIG. 2B is an example exploded back side of a printer device, in accordance with the present technology;

FIG. 3 is an example system for autonomously applying a cosmetic style, in accordance with the present technology;

FIG. 4 is another example system for autonomously applying a cosmetic style, in accordance with the present technology;

FIGS. 5A-5B show an example user interface of an example printer device, in accordance with the present technology;

FIG. 5B is an example user interface, in accordance with the present technology;

FIGS. 6A-6B are example process diagrams of an example system in use, in accordance with the present technology;

FIGS. 7A-7D are example process diagrams of an example system in use, in accordance with the present technology;

FIG. 8 is an example method of using an example system, in accordance with the present technology; and

FIG. 9 is another example method of using an example system, in accordance with the present technology.

### DETAILED DESCRIPTION

Disclosed herein are devices, systems, and methods for autonomously printing cosmetic styles, such as makeup, temporary tattoos, and other such appliques. In some embodiments, the cosmetic styles include eyebrow makeup, foundation, concealer, highlighter, blush, eyeshadow, contour, eyeliner, and the like. In some embodiments, the cosmetic styles include facial hair, hair lines, and the like. In some embodiments, a user of the system can utilize a smart device, such as a smartphone or tablet, to try on a variety of cosmetic styles. The user can then modify the cosmetic style based on their personal preferences, trending cosmetic styles, and the like. Once the user is satisfied with the cosmetic style, the user can transmit the cosmetic style to a printer device. The printer device is configured to print the cosmetic style in a location specified by the user, as the user moves the device over their skin, face, or hair.

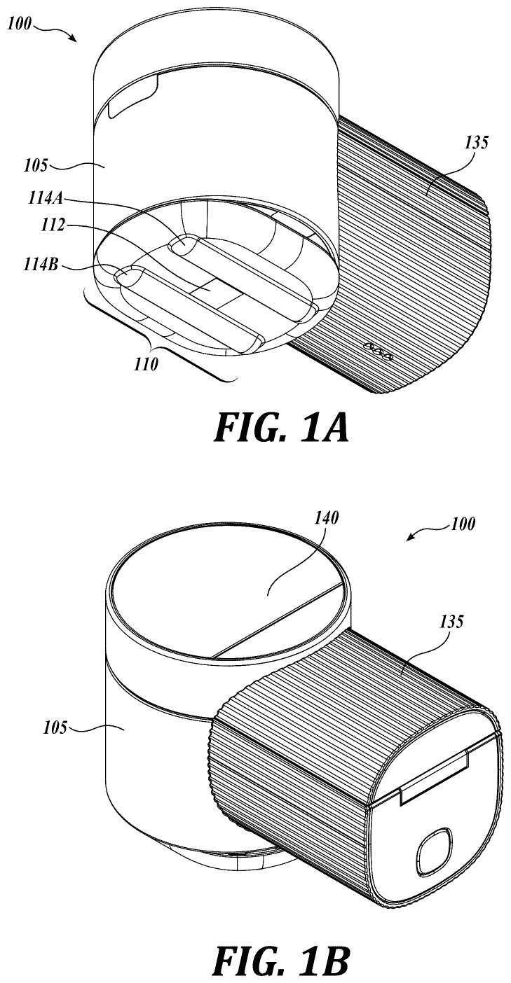

FIG. 1A is an example front side of a printer device 100, in accordance with the present technology. In some embodiments, the printer device 100 includes a body 105, and a handle 135. While printer device 100 is illustrated with a cylindrical body 105 and a cylindrical handle 135, it should be understood that the printer device 100 can take any number of forms. In some embodiments, the printer device 100 does not have a handle 135. In some embodiments, the printer device 100 includes internal circuitry, including a processor, a battery, and the like.

In some embodiments, the printer device 100 includes a processor configured to receive a makeup image file, detect a position and a curvature of the body based on the position sensor, and direct the printer 110 to print a cosmetic style based on the makeup image file in a specific location on a surface, such as a user's face. In some embodiments, the specific location is determined by the cosmetic style. For example, a lipstick cosmetic style may be printed on the lips of a user.

In some embodiments, the printer device 100 is powered through a wired connection, but the printer device 100 may also be independently powered, such as with a battery or a capacitor. In some embodiments, the printer device 100 may further include a charging port, configured to power the printer device 100.

In some embodiments, the body 105 houses the printer 110. In some embodiments, the printer 110 is positioned on a front side of the printer device 100, such as shown in FIG. 1A. In some embodiments, the printer 110 includes a printer applicator 112 and one or more spacers 114A and 114B.

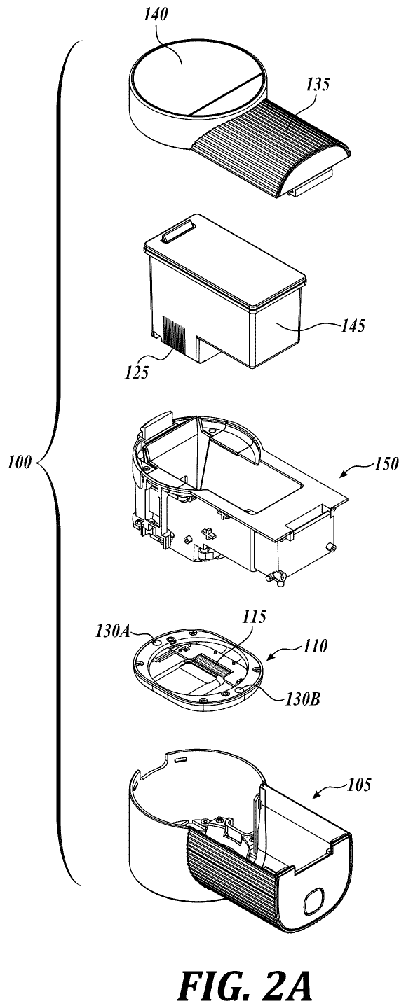

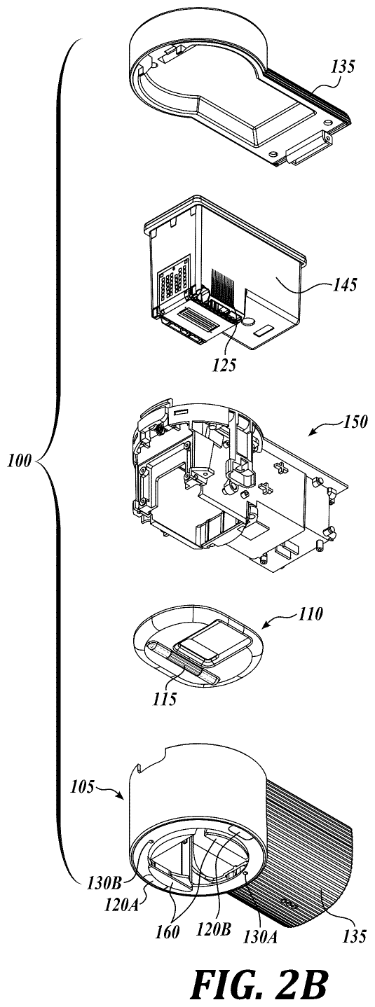

In some embodiments, the printer applicator 112 is configured to facilitate the printer 110, as shown in FIG. 2B, to print a cosmetic style onto a surface. In some embodiments, the printer applicator 112 is rectangular, square, circular, organically shaped, or the like. In some embodiments, the printer applicator 112 is in the middle of front side of the body 105. In some embodiments, the printer applicator 112 is located between the spacers 114A, 114B.

While two spacers 114A and 114B are illustrated, it should be understood that any number of spacers 114A, 114B may be on the printer 110. In some embodiments, the spacers 114A, 114B are rounded polygons, such as shown in FIG. 1A, but it should be understood that the spacers 114A, 114B can take any number of forms including spherical, rectangular, and organically shaped. In some embodiments, the spacers 114A, 114B are configured to contact a surface while the printer device 100 is passed over it, so that an optimal distance between the printer 110 (or printer applicator 112) and the surface is achieved. In some embodiments, the spaces 114A and 114B have a thickness that allows the printer applicator 112 to be in contact with a curved surface. In some embodiments, the spacers 114A and 114B may be configured to roll. In some embodiments, the spacers 114A and 114B may include at least one position sensor, as described herein. In some embodiments, in addition to maintaining a distance between the printer applicator 112 and the surface, the spacers 114A and 114B are configured to roll on the surface as the printer device 110 prints the cosmetic style.

In some embodiments, the printer device 100 includes at least one position sensor coupled to the printer 110 (as shown and described in FIG. 2A). In some embodiments, the position sensor may be housed inside the body 105, but in some embodiments, the position sensor may be located on the front side of the printer device 100 with the printer applicator 112. In some embodiments, the at least one position sensor may be inside the spacers 114A, 114B, or a combination thereof. In some embodiments, the printer device 100 further includes a camera (as shown and described in FIG. 2A). In some embodiments, the camera is configured to take a plurality of images as the printer 110 moves over a facial feature. In some embodiments, the facial feature may be an eyebrow, a nose, an eye, a wrinkle, acne, or the like.

In some embodiments, the printer 110 is a rotatably adjustable body printer 110. In some embodiments, the printer 110 is configured to articulate to more accurately scan a surface, such as a body, skin, or hair. In such embodiments, position sensor 115 may be a sensor wheel as described herein. In operation, the position sensor 115 contacts the surface and rolls as the printer 110 scans the surface. In such embodiments, the printer device 100 is able to take into account the curvature of the surface. In some embodiments, the surface is a body. In some embodiments, the printer 110 can be adjusted to fit the needs of different body types and printing environments. In some embodiments, the printer 110 has an adjustable printer applicator 112. In some embodiments, the spacers 114A and 114B may be moved or adjusted to change the size of the printer applicator 112. In some embodiments, the printer applicator 112 may be concave or convex to better contact the surface. In some embodiments, the printer 110 is capable of being articulated, so as to better contact the surface. In some embodiments, the printer 110 is coupled to the device 100 with a flexible connector (as shown and described in FIG. 2B). In some embodiments, the flexible connector is a pivot, a hinge, or a joint. In some embodiments, the flexible connector allows the printer 110 to be articulated. In some embodiments, this allows for more accurate scans of a surface. In some embodiments, this further allows the printer 110 to determine a curvature of a surface.

FIG. 1B is an example back side of a printer device 100, in accordance with the present technology. In some embodiments, the printer device 100 further includes a user interface 140. Though the user interface 140 is illustrated on the backside of the printer device 100, in some embodiments, the user interface 140 is a separate component, such as a smartphone or tablet. In some embodiments, the user interface 140 is round, but in other embodiments, the user interface 140 may take any form such as rectangular or oblong. In some embodiments, the user interface 140 includes one or more actuators, such as buttons or keys. In some embodiments, the user interface 140 includes a touch type capacitance button. In some embodiments, the user interface 140 is a touchscreen. In some embodiments, the user interface includes one or more output modules configured to output an alert. In some embodiments, the alert is a sound, vibration, or the like. In some embodiments, the alert includes an indication on how or in what direction to move the printer device 100.

FIG. 2A is an example exploded front side of a printer device, in accordance with the present technology, and FIG. 2B is an example exploded back side of a printer device, in accordance with the present technology. In some embodiments, the printer device 100 includes an internal component 150, a printer 110, and a position sensor 115. In some embodiments, the printer device 100 further includes a reservoir 145 and a processor 125.

In some embodiments, the internal component 150 is configured to hold the printer 110 in place. In some embodiments, the internal component 150 is coupled to the printer 110 and the reservoir 145.

In some embodiments, the printer 110 includes a positioning sensor 115 and at least one camera 120A, 120B. In some embodiments, the cameras 120A, 120B are located on the printer 110 but in some embodiments, the cameras 120A, 120B are located on the body 105. In some embodiments, as the printer 110 moves across a surface, such as the user's face, the cameras 120A, 120B capture a plurality of images of the surface. In some embodiments, the cameras 120A, 120B take a plurality of images of a facial feature as the printer device moves over the facial feature. In some embodiments, the printer device 100 includes two cameras 120A and 120B. In some embodiments, such as illustrated in FIG. 2A, the first camera 120B is located on a first side of the printer device 100, and the second camera 120B is located on a second side of the printer device 100, opposite the first side.

In some embodiments, such as shown in FIG. 2B, the printer device 100 includes one or more light sources 130A, 130B. In some embodiments, the light sources 130A, 130B are LEDs. Though two light sources 130A, 130B are illustrated, any number of light sources 130 may be on the printer device 100. In some embodiments, the light sources 130A, 130B are positioned on the printer 110, but in some embodiments, the light sources 130A, 130B are positioned on the front-side of the printer device 100.

In some embodiments, the printer 110 includes one or more position sensors 115. While a single position sensor 115 is illustrated in FIG. 2A, it should be understood that any number of position sensors 115 may be utilized. In some embodiments, at least one position sensor 115 is a rolling position sensor 115, such as a sensor wheel. In such embodiments, the position sensor 115 is configured to roll across the facial feature as the printer 110 is moved over the facial feature. In this manner, position sensor 115 may detect a position of the facial feature as the printer device 100 moves over the facial feature. In some embodiments, the position sensor 115 is further configured to detect the curvature of the facial feature or the user's face.

In some embodiments, the printer device 100 includes a processor 125. In some embodiments, the processor 125 is communicatively coupled to the printer 110, the position sensor 115, and the camera 120. The processor 125 may be configured to receive a makeup image file, detect a position and a curvature of the body based on the position sensor, and direct the printer to print the cosmetic style based on the makeup file in a specific location. In some embodiments, the processor is further configured to detect the lighting of the facial feature, and direct one or more light sources 130A, 130B to illuminate the light feature. While a single processor 125 is illustrated, it should be understood that any number of processors may be incorporated into the printer device 100.

In some embodiments, the printer device 100 includes one or more reservoirs 145. In some embodiments, the one or more reservoirs 145 are configured to hold one or more cosmetic inks or dyes. In some embodiments, the reservoirs hold any number of cosmetic inks or dyes needed to print the cosmetic style. In some embodiments, the one or more reservoirs 145 include a number of cartridges, such that a single reservoir 145 can hold any number of colors, compositions, finishes, or formulations of the cosmetic inks or dyes.

In some embodiments, the processor 125 is further communicatively coupled to the reservoir 145 and the printer 110. In some embodiments, the processor 125 directs the reservoir 145 and the printer 110 to fabricate a cosmetic style, such as a temporary tattoo, or makeup printed in the shape of the facial feature. In some embodiments, the cosmetic style is selected from an eyebrow, an eyeshadow, a concealer, a primer, a foundation, a blush, a lipliner, a lipstick, a bronzer, an eyeliner, a freckle pattern, a facial hair, a hair design, such as facial hair or a hairline design, or a highlighter.

In some embodiments, the printer 110 is coupled to the device 100 with a flexible connector 160. In some embodiments, the flexible connector 160 is a pivot, a hinge, or a joint. In some embodiments, the flexible connector 160 allows the printer 110 to be articulated. In some embodiments, this allows for more accurate scans or printing of the surface. In some embodiments, this further allows the printer 110 to determine the curvature of the surface.

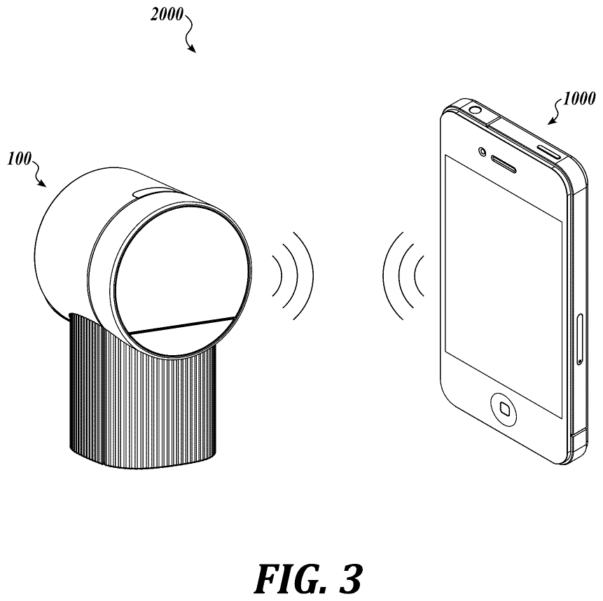

FIG. 3 is an example system 2000 for autonomously applying a cosmetic style, in accordance with the present technology. Disclosed herein is a system 2000 for applying a cosmetic style including a smart device 1000 and a printer device 100.

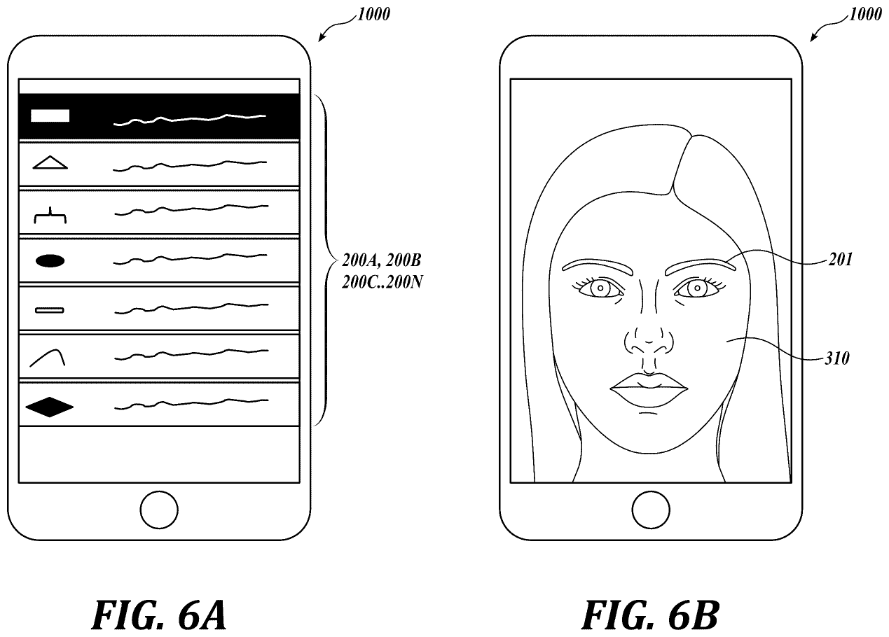

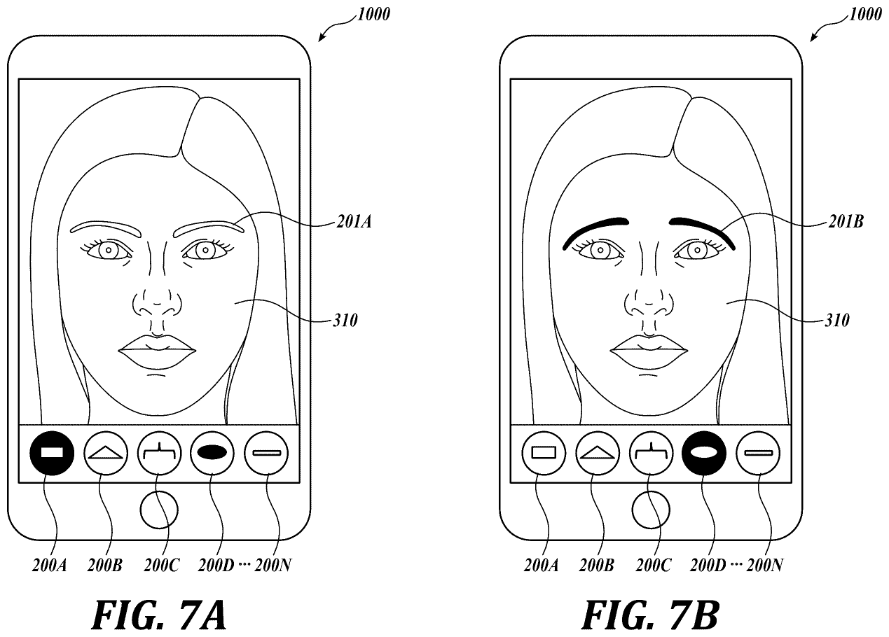

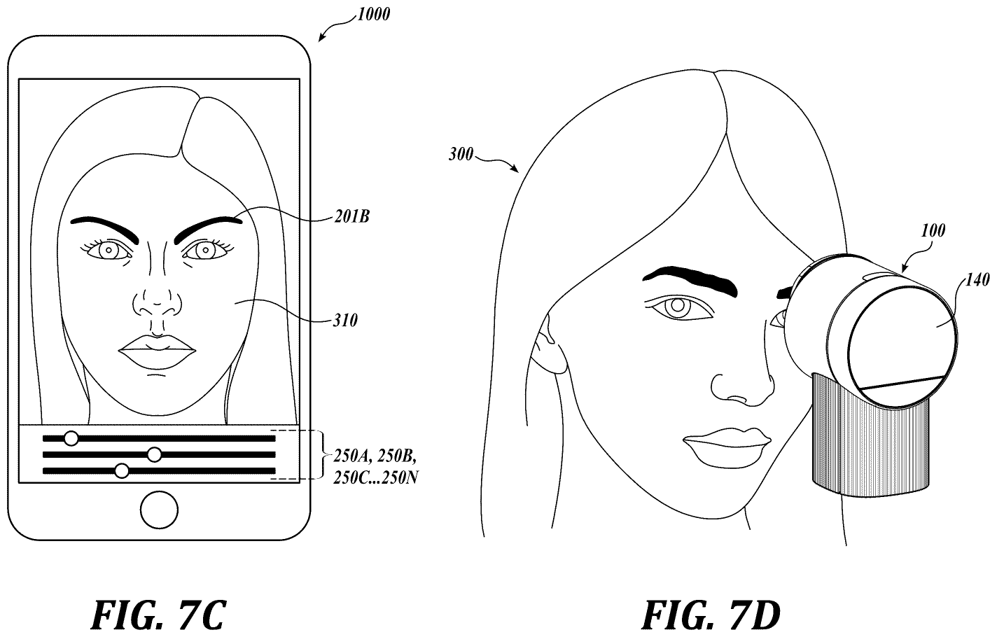

In some embodiments, the smart device 2000 includes an application configured to select the cosmetic style from a plurality of cosmetic styles, display the cosmetic style on an image of a body, and transmit the cosmetic style as a makeup image file, as shown and described herein in detail in FIGS. 6A-6B and 7A-7D. In some embodiments, such as illustrated in FIG. 3, the smart device 1000 is a smartphone. It should be understood that the smart device 1000 can take any number of forms, including a tablet, laptop, or computer. In some embodiments, the smart device 1000 is communicatively coupled to the printer device 100. In some embodiments, the smart device 1000 may be communicatively coupled to the printer device 100 by a Bluetooth, Bluetooth low energy (BLE), a Wi-Fi, or a wired connection.

In some embodiments, the printer device 100 includes at least one position sensor, one or more reservoirs each configured to hold one or more dyes, and a printer including a printer applicator. In some embodiments, the printer is configured to print the cosmetic style with the one or more dyes through the printer applicator. In some embodiments, the printer device 100 further includes a processor configured to receive the makeup image file, detect a position and a curvature of the body based on the position sensor, and direct the printer to print the cosmetic style in a specific location, as described herein.

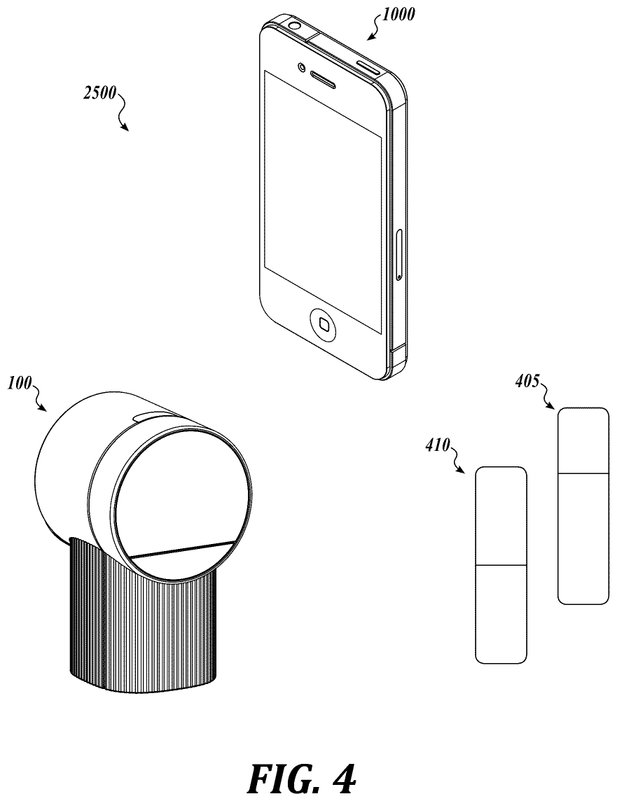

FIG. 4 is another example system 2500 for autonomously applying a cosmetic style, in accordance with the present technology. In some embodiments, the system 2500 further includes a primer 405, and a topcoat 410.

In some embodiments, the primer 405 is configured to be applied before the cosmetic style. In some embodiments, the primer 405 may be held in a container, such as shown in FIG. 4. In some embodiments, the primer 405 may include an applicator configured to brush on, spread, or apply the primer 405. In some embodiments, the primer 405 can be added to a surface manually, such as with the hand of a user of the system 2500. In some embodiments, the primer 405 is configured to prime the surface of a user's skin or hair to accept the cosmetic style. In some embodiments, the primer 405 has an adhesive property, such that it sticks to the cosmetic style. In some embodiments, the primer 405 can be placed inside a reservoir of the printer device 100. In some embodiments, the primer 405 can be printed by the printer device 100. The primer 405 may be in any form, such as a solid, a liquid, a cream, or a gel. In some embodiments, the primer 405 is configured to be sprayed onto the surface.

In some embodiments, the system further includes a topcoat 410 configured to be applied after the cosmetic style. In some embodiments, the topcoat 410 may be held in a container, such as shown in FIG. 4. In some embodiments, the topcoat 410 may include an applicator configured to brush on, spread, or apply the topcoat 410. In some embodiments, the topcoat 410 can be added to a surface manually, such as with the hand of a user of the system 2500. In some embodiments, the topcoat 410 to seal the cosmetic style to keep the cosmetic style from smudging, smearing, moving, fading or otherwise be damaged or degraded. In some embodiments, the topcoat 410 has an aesthetic property, such as a finish. In some embodiments, the finish may be a glitter finish, a glossy finish, a dewy finish, a matte finish, or the like. In some embodiments, the topcoat 410 can be placed inside a reservoir of the printer device 100. In some embodiments, the topcoat 410 can be printed by the printer device 100. The topcoat 410 may be in any form, such as a solid, a liquid, a cream, or a gel. In some embodiments, the topcoat 410 is configured to be sprayed onto the surface.

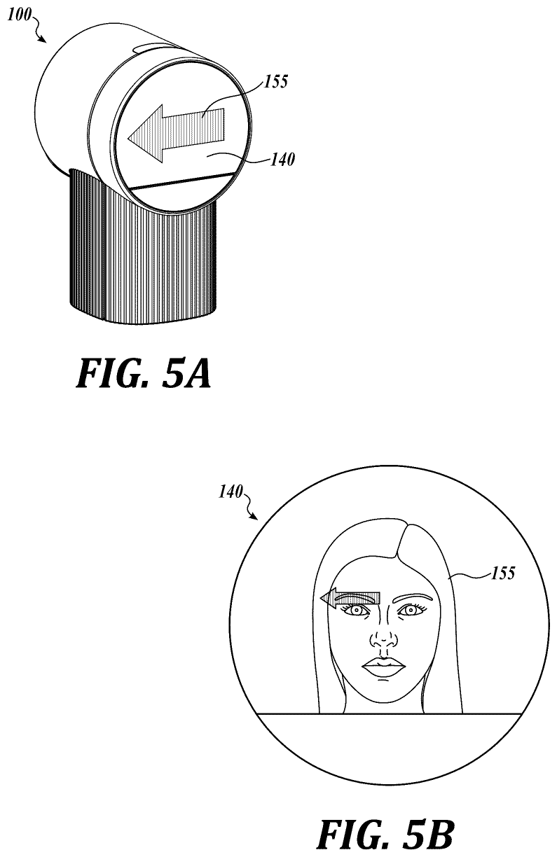

FIGS. 5A-5B show an example user interface 140 of an example printer device 100, in accordance with the present technology.

In some embodiments, the user interface 140 is configured to display a printing guide 155 in order to direct a user to properly use the printer device 100. In some embodiments, the printing guide 155 includes one or more of the plurality of images as described herein of a facial feature or surface and an arrow pointing in a direction a user can move the printer device. In some embodiments, the printing guide 155 includes a graphical representation of the facial feature 200 and an arrow pointing in the direction a user can move the printer device.

In some embodiments, the user interface 140 displays a current view of camera on the printer device 100. In some embodiments, as the user moves the printer device 100 over the surface, an image captured by the camera is displayed. In some embodiments, the printer guide 155 further includes one or more alerts to direct the user to move the printer device. In some embodiments, the alerts are visual alerts, such as arrows, auditory alerts, such as a chime or alarm, or tactile alerts such as vibrations.

FIGS. 6A-6B are example process diagrams of an example system in use, in accordance with the present technology. In some embodiments, the system may be system 2000 or system 2500 as described herein.

FIG. 6A is an example application on a smart device 1000. In some embodiments, the application is configured to provide a plurality of cosmetic styles 200A, 200B, 200C . . . 200N. In some embodiments, a user may select a cosmetic style of the plurality of styles 200A, 200B, 200C . . . 200N. In some embodiments, the user may select the cosmetic style by clicking, tapping, or otherwise choosing the cosmetic style. In FIG. 6A, the selected cosmetic style is shown in black. In some embodiments, the application may display the plurality of cosmetic styles 200A, 200B, 200C . . . 200N as a list. In some embodiments, each cosmetic style of the plurality of cosmetic styles 200A, 200B, 200C . . . 200N includes a graphical representation of the style, a description of the style, or both. In some embodiments, the application is further configured to recommend the cosmetic style from the plurality of cosmetic styles 200A, 200B, 200C . . . 200N. In some embodiments, the recommendation is based on a trending cosmetic style, a color of a user's hair, skin, or lips, a past cosmetic style selected by the user, a shape of the user's eyes, eyebrows, nose, lips, cheeks, or forehead, a location of the user, or a color of the user's clothing.

FIG. 6B is an example application on the smart device 1000 displaying an overlay of the selected cosmetic style 201 on an image of a user's face 310. In some embodiments, the image is a live video feed from a camera of the smart device 1000 of a camera of the printer device (not shown in FIG. 6B). In some embodiments, the image is a static photo, or a previously taken video. In such embodiments, a user may upload a photo or a video to the application.

FIGS. 7A-7D are example process diagrams of an example system in use, in accordance with the present technology. In some embodiments, the system may be system 2000 or system 2500 as described herein.

FIG. 7A is an example application on a smart device 1000. In some embodiments, FIG. 7A follows FIG. 6B. In some embodiments, a user may scroll through a plurality of cosmetic styles 200A, 200B, 200C, 200D . . . 200N while displaying an image of the user's face 310 and the selected cosmetic style 201A. In such embodiments, the user may select a cosmetic style 210A and change between cosmetic styles of the plurality of cosmetic styles 200A, 200B, 200C, 200D . . . 200N in real time. In some embodiments, the plurality of cosmetic styles 200A, 200B, 200C, 200D . . . 200N are shown in a manner that does not obscure the image of the user's face 310, such as at a bottom, top, or side of a screen of the smart device 1000. As shown in FIG. 7A, currently, cosmetic style 200A has been selected, and is displayed as selected cosmetic style 201A.

In FIG. 7B, a user has selected a new cosmetic style 200D, which is displayed on the image of the user 310 as selected cosmetic style 201B. In this manner, a user may change between any number of cosmetic styles from the plurality of cosmetic styles 200A, 200B, 200C, 200D . . . 200N before adjusting or printing a cosmetic style.

FIG. 7C shows a user adjusting the selected cosmetic style 201B to fit their preferences. In some embodiments, FIG. 7C follows FIG. 6B. In some embodiments, the application may suggest adjustments to the selected cosmetic style 201B. In some embodiments, the suggested adjustments may be based on a shape of the user's face, the shape of a facial feature of the user, a color of the user's hair, skin, eyes, or clothing, or a trending adjustment. In some embodiments, adjusting the selected cosmetic style 201B includes changing a color, a size, a length, a width, a hair size, a pattern, an angle, a position, a location of the cosmetic style, or a combination thereof of the cosmetic style 201B. In some embodiments, such as when the cosmetic style 201B includes discrete elements, the discrete elements of the cosmetic style 201B may be adjusted independently. For example, if the selected cosmetic style 201B is a makeup overlay of a pair of eyebrows (such as shown in FIG. 7C) each eyebrow of cosmetic style 201B may be adjusted independently. As another example, if the cosmetic style 201B is a lipstick, a blush, and an eyeshadow, the lipstick, the blush, and the eyeshadow may all be adjusted independent of one another.

In some embodiments, the selected cosmetic style 201B is adjusted with a plurality of sliders 250A, 250B, 250C . . . 250N. In some embodiments, the selected cosmetic style 201B may be adjusted with another mechanism, such as a plurality of presets, manipulation of the selected cosmetic style 201B with a touch screen, or otherwise. Once the user is satisfied with the selected cosmetic style 201B, the user may then transmit the selected cosmetic style 201B as a makeup file to a printer device 100. In some embodiments, the application may further store the selected and/or adjusted cosmetic style 201B as a preset, so that a user can select and/or print the same cosmetic style 201B later.

In FIG. 7D, the user 300 applies the selected and/or adjusted cosmetic style 201 to a surface with the printer device 100. In some embodiments, the surface is a face, skin, or hair. In some embodiments, the user 300 may be a second person, where a first person applies the cosmetic style to the second person. In some embodiments, the first person may be a trained user, such as in a store or at a makeup counter.

In operation, the printer device 100 receives the makeup image file of the selected cosmetic style 201B. The user 300 may hold the printer device 100 from handle 135 and move the printer 110 over a surface. In some embodiments, the surface is a face. In some embodiments, the surface is skin or hair. In some embodiments, the surface is a facial feature. As the printer device 100 is moved over the surface, the printer device 100 can detect a position and a curvature of the body based on the position sensor and direct the printer to print the cosmetic style in a specific location. In some embodiments, the user 300 may direct the printer device 100 over the surface before selecting, adjusting, and/or printing a cosmetic style. In such embodiments, the printer device 100 may be configured to detect one or more facial features of the user 300 to allow the application to provide a recommendation based on the user's facial features, detect a position of the one or more facial features, or a combination thereof.

In some embodiments, the printer device 100 can sense its own location on the surface, and automatically apply the one or more cosmetic style to the specific location on the surface. In some embodiments, the cosmetic style may be manually applied, such as with a button or switch. In this manner, the printer device 100 prints the cosmetic style only in the location desired by the user, based on the cosmetic style selected, the adjustments made to the cosmetic style, or a combination thereof.

In another aspect, disclosed herein is a method of autonomously applying a cosmetic style with the systems described herein. In some embodiments, the method includes selecting the cosmetic style from a plurality of cosmetic styles, displaying the cosmetic style on an image of a body, transferring the cosmetic style as an image file to a printer device, moving the printer device over the body, and printing the cosmetic style onto the body at a specific location based on one or more position sensors on the printer device.

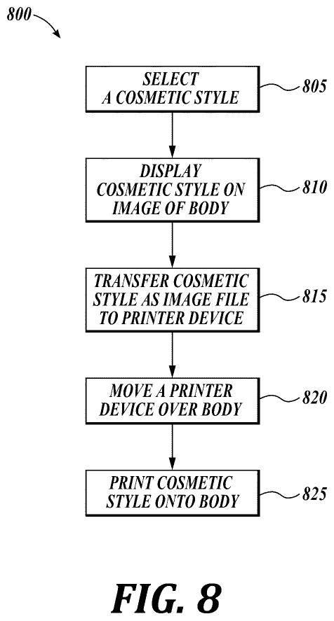

FIG. 8 is an example method 800 of using an example system (such as system 2000 or system 2500 described herein), in accordance with the present technology.

In block 805, a cosmetic style is selected. In some embodiments, the cosmetic style is selected from a plurality of cosmetic styles. In some embodiments, the cosmetic style is selected as shown in FIG. 6A, 7A, or a combination thereof. In some embodiments, the cosmetic style is selected from an eyebrow, an eyeshadow, a concealer, a primer, a foundation, a blush, a lipliner, a lipstick, a bronzer, an eyeliner, a freckle pattern, a facial hair, a hair design, a highlighter, or a combination thereof.

In block 810, the cosmetic style is displayed on an image of a body. In some embodiments, the image of the body is a live video feed from a smart device or the printer device. In some embodiments, the cosmetic style is displayed as shown in FIG. 6B, 7B, or a combination thereof.

In block 815, the cosmetic style is stored as an image file and transferred to a printer device. In some embodiments, the image file is a makeup image file. In some embodiments, the image file may be stored on a smart device application. In some embodiments, the printer device receives the image file of the cosmetic style through a wireless or wired connection, such as shown in FIG. 2.

In block 820, the printer device is moved over the body. In some embodiments, the printer device is moved as shown in FIG. 7D. In some embodiments, the printer device is moved by an operator of the device onto a person. In some embodiments, the printer device is moved by a user of the printer device.

In block 825, the cosmetic style is printed onto the body. In some embodiments, the cosmetic style is printed in a location of the body as shown in the image of the body. In some embodiments, the cosmetic style is printed by the printer device. In some embodiments, the cosmetic style is made of one or more cosmetic dyes or inks stored inside one or more reservoirs in the printer device. In some embodiments, a primer may be applied before the cosmetic style is printed, and a topcoat may be applied after the cosmetic style is printed.

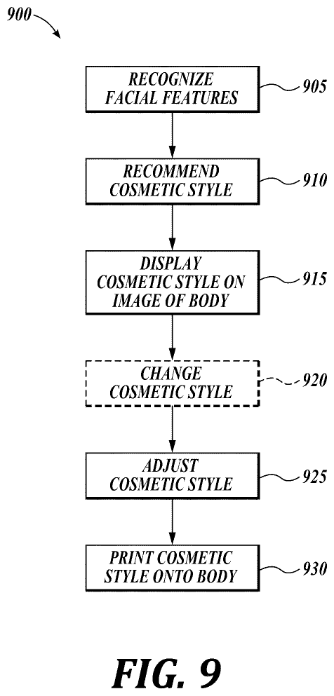

FIG. 9 is another example method 900 of using an example system (such as system 2000), in accordance with the present technology.

In block 805. a plurality of facial features in the image of the body are recognized. In some embodiments, the plurality of facial features is recognized by the application of the smart device. In some embodiments, the plurality of facial features is recognized by the printer device, through one or more cameras on the printer device. In some embodiments, the depth and/or curvature of the plurality of facial features is recognized by the proximity sensor on the printer device. As described herein, facial features may include cheeks, cheekbones, eyes, eyelids, waterlines, lips, eyebrows, noses, hair lines, ears, chins, or the like.

In block 910, the system recommends a cosmetic style. In some embodiments, the cosmetic style is recommended based on a trending cosmetic style, a color of a user's hair, skin, eyes, or lips, a past cosmetic style selected by the user, a shape of the user's eyes, eyebrows, nose, lips, cheeks, or forehead, a location of the user, or a color of the user's clothing. In some embodiments, the cosmetic style is selected from an eyebrow, an eyeshadow, a concealer, a primer, a foundation, a blush, a lipliner, a lipstick, a bronzer, an eyeliner, a freckle pattern, a facial hair, a hair design, a highlighter, or a combination thereof.

In block 915, the cosmetic style is displayed on the image of the body, as described herein.

Optionally, in block 920, the user may change the cosmetic style. In some embodiments, changing the cosmetic style includes selecting another cosmetic style from the plurality of cosmetic styles instead of the cosmetic style. In some embodiments, the user may switch the cosmetic style multiple times before deciding the print the cosmetic style.

In block 925, the user may adjust the cosmetic style. In some embodiments, adjusting the cosmetic style includes changing a color, a size, a length, a width, a hair size, a pattern, an angle, a position, a location of the cosmetic style, or a combination thereof of the cosmetic style.

In block 930, the system may then print the cosmetic style onto a body of the user. In some embodiments, as described herein, the printer device may accurately detect and print the cosmetic style onto a specific location on the user's body.

It should be understood that method 800 and method 900 should be interpreted as merely representative. In some embodiments, process blocks of method 800 and 900 may be performed simultaneously, sequentially, in a different order, or even omitted, without departing from the scope of this disclosure.

The present application may reference quantities and numbers. Unless specifically stated, such quantities and numbers are not to be considered restrictive, but representative of the possible quantities or numbers associated with the present application. Also, in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A, B, and C,” for example, means (A), (B), (C), (A and B), (A and C), (B and C), or (A, B, and C), including all further possible permutations when greater than three elements are listed.

Embodiments disclosed herein may utilize circuitry in order to implement technologies and methodologies described herein, operatively connect two or more components, generate information, determine operation conditions, control an appliance, device, or method, and/or the like. Circuitry of any type can be used. In an embodiment, circuitry includes, among other things, one or more computing devices such as a processor (e.g., a microprocessor), a central processing unit (CPU), a digital signal processor (DSP), an application-specific integrated circuit (ASIC), a field-programmable gate array (FPGA), or the like, or any combinations thereof, and can include discrete digital or analog circuit elements or electronics, or combinations thereof.

An embodiment includes one or more data stores that, for example, store instructions or data. Non-limiting examples of one or more data stores include volatile memory (e.g., Random Access memory (RAM), Dynamic Random Access memory (DRAM), or the like), non-volatile memory (e.g., Read-Only memory (ROM), Electrically Erasable Programmable Read-Only memory (EEPROM), Compact Disc Read-Only memory (CD-ROM), or the like), persistent memory, or the like. Further non-limiting examples of one or more data stores include Erasable Programmable Read-Only memory (EPROM), flash memory, or the like. The one or more data stores can be connected to, for example, one or more computing devices by one or more instructions, data, or power buses.

In an embodiment, circuitry includes a computer-readable media drive or memory slot configured to accept signal-bearing medium (e.g., computer-readable memory media, computer-readable recording media, or the like). In an embodiment, a program for causing a system to execute any of the disclosed methods can be stored on, for example, a computer-readable recording medium (CRMM), a signal-bearing medium, or the like. Non-limiting examples of signal-bearing media include a recordable type medium such as any form of flash memory, magnetic tape, floppy disk, a hard disk drive, a Compact Disc (CD), a Digital Video Disk (DVD), Blu-Ray Disc, a digital tape, a computer memory, or the like, as well as transmission type medium such as a digital and/or an analog communication medium (e.g., a fiber optic cable, a waveguide, a wired communications link, a wireless communication link (e.g., transmitter, receiver, transceiver, transmission logic, reception logic, etc.). Further non-limiting examples of signal-bearing media include, but are not limited to, DVD-ROM, DVD-RAM, DVD+RW, DVD-RW, DVD-R, DVD+R, CD-ROM, Super Audio CD, CD-R, CD+R, CD+RW, CD-RW, Video Compact Discs, Super Video Discs, flash memory, magnetic tape, magneto-optic disk, MINIDISC, non-volatile memory card, EEPROM, optical disk, optical storage, RAM, ROM, system memory, web server, or the like.

The detailed description set forth above in connection with the appended drawings, where like numerals reference like elements, are intended as a description of various embodiments of the present disclosure and are not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result. Generally, the embodiments disclosed herein are non-limiting, and the inventors contemplate that other embodiments within the scope of this disclosure may include structures and functionalities from more than one specific embodiment shown in the figures and described in the specification.

In the foregoing description, specific details are set forth to provide a thorough understanding of exemplary embodiments of the present disclosure. It will be apparent to one skilled in the art, however, that the embodiments disclosed herein may be practiced without embodying all the specific details. In some instances, well-known process steps have not been described in detail in order not to unnecessarily obscure various aspects of the present disclosure. Further, it will be appreciated that embodiments of the present disclosure may employ any combination of features described herein.

The present application may include references to directions, such as “vertical,” “horizontal,” “front,” “rear,” “left,” “right,” “top,” and “bottom,” etc. These references, and other similar references in the present application, are intended to assist in helping describe and understand the particular embodiment (such as when the embodiment is positioned for use) and are not intended to limit the present disclosure to these directions or locations.

The present application may also reference quantities and numbers. Unless specifically stated, such quantities and numbers are not to be considered restrictive, but exemplary of the possible quantities or numbers associated with the present application. Also, in this regard, the present application may use the term “plurality” to reference a quantity or number. In this regard, the term “plurality” is meant to be any number that is more than one, for example, two, three, four, five, etc. The term “about,” “approximately,” etc., means plus or minus 5% of the stated value. The term “based upon” means “based at least partially upon.”

The principles, representative embodiments, and modes of operation of the present disclosure have been described in the foregoing description. However, aspects of the present disclosure, which are intended to be protected, are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure as claimed.

While illustrative embodiments have been illustrated and described, it will be appreciated that various changes can be made therein without departing from the spirit and scope of the invention.

The embodiments of the invention in which an exclusive property or privilege is claimed are defined as follows:

1. A system for autonomously applying a cosmetic style, the system comprising:
a smart device comprising an application configured to:
select the cosmetic style from a plurality of cosmetic styles;
display the cosmetic style on an image of a body; and
transmit the cosmetic style as a makeup image file; and
a printer device, comprising:
at least one position sensor;
one or more reservoirs each configured to hold one or more dyes;
a printer comprising a printer applicator, wherein the printer is configured to print the cosmetic style with the one or more dyes through the printer applicator; and
a processor configured to:
receive the makeup image file,
detect a position and a curvature of the body based on the position sensor, and
direct the printer to print the cosmetic style in a specific location.

2. The system of claim 1, wherein the system further comprises a primer configured to be applied before the cosmetic style.

3. The system of claim 1, wherein the system further comprises a topcoat configured to be applied after the cosmetic style.

4. The system of claim 1, wherein the printer device further comprises:
a camera configured to take a plurality of images, wherein the specific location is further informed by the plurality of images; and
a light source configured to illuminate the body.

5. The system of claim 4, wherein the camera is a first camera, and the device further comprises a second camera, and wherein the first camera is located on a first side of the printer applicator, and the second camera is located on a second side opposite the first side of the printer applicator.

6. The system of claim 1, wherein the printer device further comprises a user interface configured to provide a printing guide.

7. The system of claim 1, wherein the position sensor is a rolling position sensor.

8. The system of claim 7, wherein the rolling position sensor is configured to contact the body as the rolling position sensor rolls over the body and to measure a curvature of the body.

9. The system of claim 1, wherein the printer is coupled with the printer device with a flexible connector, and wherein the flexible connector is configured to articulate the printer.

10. The system of claim 4, wherein the image of the body is a live video feed of the smart device or the printer device.

11. The system of claim 1, wherein the application is further configured to recommend the cosmetic style from the plurality of cosmetic styles.

12. The system of claim 11, wherein the recommendation is based on a trending cosmetic style, a color of a user's hair, skin, or lips, a past cosmetic style selected by the user, a shape of the user's eyes, eyebrows, nose, lips, cheeks, or forehead, a location of the user, a color of the user's clothing, or a combination thereof.

13. A method of autonomously applying a cosmetic style with the system of claim 1, the method comprising:
selecting the cosmetic style from a plurality of cosmetic styles;
displaying the cosmetic style on an image of a body;
transferring the cosmetic style as an image file to a printer device;
moving the printer device over the body; and
printing the cosmetic style onto the body at a specific location based on one or more position sensors on the printer device.

14. The method of claim 13, wherein the method further comprises recommending the cosmetic style based on a trending cosmetic style, a color of a user's hair, skin, or lips, a past cosmetic style selected by the user, a shape of the user's eyes, eyebrows, nose, lips, cheeks, or forehead, a location of the user, a color of the user's clothing or a combination thereof.

15. The method of claim 13, wherein the image of the body is a live video feed from a smart device or the printer device.

16. The method of claim 13, wherein the method further comprises recognizing a plurality of facial features in the image of the body before displaying the cosmetic style.

17. The method of claim 13, wherein the method further comprises selecting another cosmetic style in place of the cosmetic style.

18. The method of claim 13, wherein the cosmetic style is selected from an eyebrow, an eyeshadow, a concealer, a primer, a foundation, a blush, a lipliner, a lipstick, a bronzer, an eyeliner, a freckle pattern, a facial hair, a hair design, a highlighter, or a combination thereof.

19. The method of claim 13, wherein the method further comprises adjusting the cosmetic style.

20. The method of claim 19, wherein adjusting the cosmetic style comprises changing a color, a size, an angle, a length, a width, a hair size, a pattern, a position, a location of the cosmetic style, or a combination thereof.
